(19) United States
(12) Patent Application Publication
(10) Pub. No.: US 2016/0297723 A1
(43) Pub. Date: Oct. 13, 2016

(54) FERTILISER COMPOSITION

(71) Applicants: Warren John BANKS, Mt Maunganui South, Tauranga (NZ); Warwick David CATTO, Tauranga (NZ); Terrence John SMITH, Matua, Tauranga (NZ); Aaron David STAFFORD, Mt Maunganui South, Tauranga (NZ); Mohammad ZAMAN, Mt Maunganui South, Tauranga (NZ); BALLANCE AGRI-NUTRIENTS LIMITED, Mt Maunganui South, Tauranga (NZ)

(72) Inventors: Warren John BANKS, Mount Maunganui South (NZ); Warwick David CATTO, Tauranga (NZ); Terrence John SMITH, Mount Maunganui South (NZ); Aaron David STAFFORD, Mount Maunganui South (NZ); Mohammad ZAMAN, Mount Maunganui South (NZ)

(73) Assignee: Ballance Agri-Nutrients Limited, Mount Maunganui South (NZ)

(21) Appl. No.: 15/038,632

(22) PCT Filed: Nov. 21, 2014
(86) PCT No.: PCT/IB2014/066217

§ 371 Date: May 23, 2016

(30) Foreign Application Priority Data
Nov. 21, 2013 (NZ) 618103

(51) Int. Cl. C05F 11/10; C05G 3/00; C05C 9/00; A01N 37/36; A01N 43/38; A01N 43/12; A01N 43/90

(52) U.S. Cl. CPC C05F 11/10; A01N 43/12; C05G 3/0041; A01N 43/90; A01N 37/36; A01N 43/38; C05C 9/005

(57) ABSTRACT

The present invention provides fertiliser compositions comprising granules of one or more plant hormones, such as auxin or gibberellic acid or a salt thereof, in addition to methods of manufacturing and using such compositions and granules, for example for improving plant health and production, such as treating the soil of pastoral land to increase pasture production.

### FIELD OF THE INVENTION

The present invention relates to compositions comprising granules of plant hormones, for example gibberellic acid-coated granules, methods of preparing such compositions, and application of such compositions to soil.

### BACKGROUND TO THE INVENTION

The agricultural (including horticultural) use of liquid formulations of plant hormones is known. For example, Gibberellic acid (GA), is applied to plants in liquid formulations typically by foliar spraying (see Khan N A et al., (1996) “Effect of gibberellic acid and nitrogen on carbonic anhydrase activity and mustard biomass” in Biologia Plantarum volume 38 at pages 601-603), or seeds are soaked in GA (see Khan N A et al., (1996) “Effect of gibberellic acid spray on nitrogen yield efficiency of mustard grown with different nitrogen levels” in Plant Growth Regulation volume 38 at pages 243-247).

There remains a need for agriculturally acceptable compositions comprising plant hormones that do not need to be formulated or applied as a liquid.

It is an object of the present invention to provide agriculturally acceptable compositions comprising granules of plant hormone, to provide said granules, for example a granule containing gibberellic acid, to provide methods of preparing and using said compositions and granules, or to at least provide the public with a useful choice.

### SUMMARY OF THE INVENTION

In a first aspect the invention relates to one or more granules, the granules comprising one or more plant hormones, wherein the granules
a) have a bulk density of from about 0.5 g/cm³ to about 1.5 g/cm³, or
b) have a mean diameter (weight-based) of from about 1 mm to 5 mm, or
c) have a particle size distribution whereby at least 90% of the granules have a diameter of from 1 mm to 5 mm, or
d) have a particle size distribution whereby at least 90% of the granules have a diameter within 1 mm of the mean diameter, or
e) have a hardness of from about 10 N to about 70 N, or
f) comprise less than about 0.5% w/w plant hormone, or
g) any combination of two or more of (a) to (f) above.

In one embodiment, the granules of the invention comprise one or more carriers and/or one or more additional agents.

In a second aspect the invention relates to a fertiliser composition comprising the granules of the present invention.

For example, in one embodiment the plant hormone is gibberellic acid or a salt thereof, such that the invention relates to a fertiliser composition comprising granules, the granules comprising gibberellic acid or a salt thereof.

In another aspect the invention relates to a method of producing granules comprising one or more plant hormones, the method comprising
(A) providing one or more plant hormones,
(B) forming granules comprising the one or more plant hormones by
   i) wet or dry mixing the one or more plant hormones and optionally one or more carriers and granulating the mixture, or
   ii) granulating one or more carriers and at least partially coating the granule with the one or more plant hormones, or
   iii) granulating a composition of the one or more plant hormones and an agriculturally acceptable carrier and at least partially coating the granule with one or more additional agents, or
   iv) any combination of (i) to (iii) above, and
(C) recovering the granules.

For example, in one embodiment the plant hormone is gibberellic acid or a salt thereof, such that the invention relates to a method of producing granules comprising gibberellic acid, the method comprising
(A) providing gibberellic acid or a salt thereof,
(B) forming granules comprising the gibberellic acid or salt thereof by
   i) wet or dry mixing the gibberellic or salt thereof and optionally one or more carriers and granulating the mixture, or
   ii) granulating one or more carriers and at least partially coating the granule with gibberellic acid or salt thereof, or
   iii) granulating a composition of gibberellic acid and an agriculturally acceptable carrier and at least partially coating the granule with one or more additional agents, or
   iv) any combination of (i) to (iii) above, and
(C) recovering the granules.

In another aspect the invention relates to a method of providing fertilizer to a plant or a locus at which a plant is or is to be planted, the method comprising applying granules comprising one or more plant hormones and one or more carriers and/or one or more additional agents to the plant or the locus, for example to the soil of pastoral or arable land, or to the media in which or surfaces on which plants are grown, for example, in horticultural greenhouses and the like.

For example, in one embodiment the plant hormone is gibberellic acid or a salt thereof, such that the invention relates to a method comprising applying granules comprising gibberellic acid or a salt thereof and one or more carriers and/or one or more additional agents to the soil of pastoral land.

In one aspect the invention relates to a method of improving plant health, production, or nutritional, environmental or economic value, or of improving the health-promoting or productive capacity or the nutritional, environmental or economic value of a locus where a plant is or is to be planted, the method comprising applying a composition of the invention or granules of the invention to the plant or the locus.

In one embodiment, the improvement is an improvement in yield. For example, the plant to which the composition or granules of the invention is applied is a crop plant, wherein the improvement is an improvement in crop yield.

In one embodiment the improvement is a reduction in plant nitrogen concentration.

In one embodiment, the improvement is a reduction in plant cadmium concentration, or in cadmium concentration of the locus.

In another embodiment, the improvement is a reduction in nitrate levels in the plant, or present in the locus, and/or nitrate poisoning risk to animals grazing.

In another embodiment, the improvement is a reduction in cadmium intake by grazing animals, or in cadmium concentration in the grazing animals or a product from or output of said animals.

In another embodiment, the improvement is a reduction in the nitrogen concentration of forage grazed by an animal or reduction in the nitrogen concentration of a product of or output from a grazing animal. For example, in an exemplary embodiment the improvement is a reduction in the nitrogen or urea concentration of milk from a grazing animal, such as a bovine, or a reduction in the nitrogen concentration of meat from a grazing animal, such as a bovine, or a reduction in urine nitrogen concentration.

In another embodiment, the improvement is a reduction in cation leaching, for example, cation leaching in or from the locus.

In another embodiment, the improvement is a reduction in nitrous oxide production, for example, nitrous oxide production in or from the locus.

In another embodiment, the improvement is a reduction in nitrogen leaching, for example, nitrogen leaching in or from the locus.

In another aspect the invention relates to a method of treating the soil of pastoral land to increase pasture production, the method comprising applying granules comprising one or more plant hormones and optionally one or more carriers and/or one or more additional agents to the soil of pastoral land to increase pasture production.

For example, in one embodiment the plant hormone is gibberellic acid or a salt thereof, such that the invention relates to a method of treating the soil of pastoral land to increase pasture production, the method comprising applying granules comprising gibberellic acid or a salt thereof and optionally one or more carriers and/or one or more additional agents to the soil of pastoral land to increase pasture production.

In another aspect the invention relates to use of granules comprising one or more plant hormones and optionally one or more carriers and/or one or more additional agents to increase pasture production on pastoral land.

For example, in one embodiment the plant hormone is gibberellic acid or a salt thereof, such that the invention relates to use of granules comprising gibberellic acid or a salt thereof and optionally one or more carriers and/or one or more additional agents to increase pasture production on pastoral land.

Any one or more of the following embodiments may relate to any of the aspects described herein.

In one embodiment the granules comprise one or more carriers coated with one or more plant hormones, such as gibberellic acid or a salt thereof. Accordingly, in certain embodiments the granules comprise a carrier core, directly or indirectly coated with one or more plant hormones.

In one embodiment, the granules comprise a carrier core to which it is applied one or more plant hormones, optionally together with one or more agriculturally acceptable carriers.

In one particularly contemplated embodiment, the granules comprise a carrier core, one or more intermediate layers comprising an agriculturally acceptable carrier, such as a sticking agent or tackifier, and one or more outer layers comprising one or more plant hormones, optionally together with one or more agriculturally acceptable carriers.

For example, the granules are prepared by a method comprising
(A) providing one or more carriers, one or more sticking agents, one or more plant hormones, and optionally one or more additional agents,
(B) forming granules comprising the one or more carriers, the one or more sticking agents, and optionally the one or more additional agents by
   i) wet or dry mixing the one or more carriers, the one or more sticking agents, and optionally the one or more additional agents and granulating the mixture, or
   ii) granulating one or more carriers and at least partially coating the granule with the one or more sticking agents, and optionally the one or more additional agents, and
   iii) at least partially coating the granule with the one or more plant hormones,
   iv) any combination of (i) to (iii) above, and
(C) recovering the granules.

In one embodiment the granules comprise a substantially homogeneous mixture of one or more carriers and/or one or more additional agents and one or more plant hormones.

In various embodiments, the one or more plant hormones are selected from the group consisting of one or more gibberellins, one or more auxins, one or more cytokinins, abscisic acid, ethylene, salicylic acid, one or more brassinosteroids, one or more jasmonates, one or more peptide hormones, one or more polyamines, nitric oxide, and one or more strigolactones.

In one embodiment, the one or more auxins is indole-3-acetic acid (IAA), 1-Naphthaleneacetic acid (NAA), or indole-3-butyric acid (IBA). In one embodiment, the cytokinin is zeatin. In one embodiment, the brassinosteroids is brassinolide.

For example, the granules comprise a substantially homogeneous mixture of one or more carriers and/or one or more additional agents and gibberellic acid or a salt thereof.

In one embodiment, the granules comprise one or more additional agents, such as one or more fertilizers, one or more trace elements, one or more nitrification inhibitors, one or more urease inhibitors, or other agents.

In various embodiments the granules have a mean diameter of about 500, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800 or 5,000 μm, and useful ranges may be selected between any of these values.

In various embodiments the granules have a mean diameter of about 500 to about 5,000 μm. Preferably the granules have a mean diameter of about 2,000 to about 4,000 μm.

In various embodiments, the granules have a hardness of from about 10 N to about 70 N. For example, in one embodiment the granules have a hardness of from about 20 N to about 60 N, of from about 20 N to about 50 N, or of from about 30 N to about 50 N.

In one embodiment the granules consist of a granule at least partially dry coated with the one or more plant hormones, such as gibberellic acid or a salt thereof.

In one embodiment the granules consist of a granule at least partially wet coated with one or more plant hormones, such as gibberellic acid or a salt thereof.

In one embodiment the granules comprise about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3 mg plant hormone per gram of granule.

In one example the granules comprise about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3 mg gibberellic acid or salt thereof per gram of granule.

In various embodiments, the granules comprise less than about 0.5% w/w plant hormone, less than about 0.4% w/w plant hormone, less than about 0.3% w/w plant hormone, less than about 0.2% w/w plant hormone, less than about 0.1% w/w plant hormone, or less than about 0.05% w/w plant hormone.

In one embodiment the one or more plant hormones, such as the gibberellic acid or a salt thereof, at least partially coats the granule surface.

In one embodiment the granule comprises urea, such as urea sourced from urea phosphate, urea sulphur, urea potash or a mixture thereof.

In one embodiment the granule comprises one or more carriers and/or one or more additional agents and one or more plant hormones as a granule comprising the one or more plant hormones in a carrier, encapsulated or coated by one or more carriers or one or more additional agents. In one embodiment, the granule of one or more plant hormones is formed with a carrier. In some embodiments the carrier is selected from a clay such as a potassium, sodium, calcium, or aluminium bentonite, a zeolite (e.g. mordenite) or perlite, or a combination thereof. In one embodiment, once the plant hormone granule is formed, the urea is applied to the granule.

In one particularly contemplated embodiment the granule comprises one or more carriers and/or one or more additional agents and gibberellic acid as a granule comprising gibberellic acid in a carrier, encapsulated or coated by one or more carriers and/or one or more additional agents.

In various embodiments, the one or more plant hormones coats at least 10%, 15, 20, 25, 30, 35, 40, 45, 50, 55, 60, 65, 70, 75, 80, 85, 90 or 95% of the granule surface.

For example, the gibberellic acid or a salt thereof coats at least 10, 15, 20, 25, 30, 35, 40, 45, 50, 55, 60, 65, 70, 75, 80, 85, 90 or 95% of the granule surface.

In particularly contemplated embodiments, the one or more plant hormones, such as the gibberellic acid or a salt thereof, the coats at least 75% of the granule surface.

In one embodiment, the one or more plant hormones, such as the gibberellic acid or a salt thereof, is sprayed onto the granules.

In various embodiments, the composition or granules of the invention are applied to a plant or a locus where a plant is or is to be planted, for example using standard solid-phase distribution techniques. For example, granules of the invention are blown or disbursed over a locus where one or more plants are or are to be planted. In one exemplary embodiment the granules are sprayed or blown onto a pasture.

In one embodiment the granules are applied to substantially cover the locus, for example a pasture.

In one embodiment the granules are applied to provide about 5, 10, 15, 20, 25, 30, 35, 40, 45, 50, 55, 60, 65, 70, 75, 80, 85, 90, 95 or 100 g/Ha of one or more plant hormones, and useful ranges may be selected between any of these values.

For example, the granules are applied to provide about 5, 10, 15, 20, 25, 30, 35, 40, 45, 50, 55, 60, 65, 70, 75, 80, 85, 90, 95 or 100 g/Ha of gibberellic acid or a salt thereof, and useful ranges may be selected between any of these values.

In some embodiments the granules are applied, for example to pasture, to provide about 10 to about 30 g/Ha and more preferably about 25 to about 30 g/Ha of one or more plant hormones.

For example, the granules are applied, for example to pasture, to provide about 10 to about 30 g/Ha and more preferably about 25 to about 30 g/Ha of gibberellic acid or a salt thereof.

In a specifically contemplated embodiment, the granules comprise not more than about 0.3% w/w plant hormone, and are applied to the plant or locus at a rate of at least about 10 kg granule per hectare. For example, the granules comprise about 0.3% w/w plant hormone, and are applied to the plant or locus at a rate of at least about 20 kg granule per hectare. In another example, the granules comprise about 0.15% w/w plant hormone, and are applied to the plant or locus at a rate of at least about 20 kg granule per hectare.

For example, the granules are applied to the plant or locus at a rate of about 10 g/ha gibberellic acid, for example as a gibberellic acid-coated nitrogen-containing granules applied at a rate to provide 20 kg N per hectare. In another specifically contemplated example, the granules are applied to the plant or locus at a rate of about 20 g/ha gibberellic acid, for example as a gibberellic acid-coated nitrogen-containing granules applied at a rate to provide 20 kg N per hectare. In another example, the granules are applied to the plant or locus at a rate of about 30 g/ha gibberellic acid, for example as a gibberellic acid-coated nitrogen-containing granules applied at a rate to provide 20 kg N per hectare. In another example, the granules are applied to the plant or locus at a rate of about 20 g/ha gibberellic acid, for example as a gibberellic acid-coated urea granules applied at a rate to provide 50 kg N per hectare.

In one embodiment, the granules increase plant growth, such as pasture growth, or to increase plant yield, such as pasture yield.

In one embodiment, the granules increase pasture dry matter production by at least about 10, 15, 20, 25, 30, 35, 40, 45, 50, 55, 60, 65, 70, 75, 80, 85, 90, 95 or 100%, and useful ranges may be selected between any of these values.

In some embodiments, the granules increase pasture dry matter production by at least about 15% to about 50% and more preferably about 15% to about 20%.

In one embodiment the granules are applied before application of irrigation water or before a period of forecast rainfall.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### DETAILED DESCRIPTION OF THE INVENTION

The present invention relates to a fertiliser composition and its use.

The fertiliser composition comprises granules, each granule comprising one or more plant hormones, such as gibberellic acid or a salt thereof, and optionally one or more carriers and/or one or more additional agents.

The present invention provides for the application of granules, for example to the soil, enabling the advantages of solid phase application while being as effective as liquid application to the foliage of plants. The application of a granule comprising plant hormone performs as well as liquid, particularly foliar, application of the plant hormone, while providing benefit in terms of ease of application.

### Plant Hormones

Plant hormones are substances which modulate cellular functions and regulate growth. It is generally accepted that there are five classes of plant hormones: Auxins, such as indole-3-acetic acid (IAA), 1-Naphthaleneacetic acid (NAA), and indole-3-butyric acid (IBA); Abscisic acid (ABA); Cytokinins, such as zeatin; Ethylene; and Gibberellins. Other exemplary plant hormones have been reported, including Brassinosteroids, such as brassinolide, Salicylic acid, Jasmonates, Plant peptide hormones, Polyamines, Nitric oxide, and Strigolactones.

These plant hormones, including those which have been utilised in agricultural, including horticultural, applications, are suitable for use in the present invention.

### Gibberellic Acid

Gibberellic acid (also known as Gibberellin A3, GA, and GA₃) is a hormone found in plants and has the chemical formula is C₁₉H₂₂O₆. When purified gibberellic acid is a white to pale-yellow solid. The gibberellic acid can also be present in an ammonium or potassium form.

Gibberellic acid promotes growth and elongation of cells and stimulates the cells of germinating seeds to produce mRNA molecules that code for hydrolytic enzymes. Since GA regulates growth, applications of low concentrations can have an effect while too much can lead to opposite effects.

### Granules

As used herein the term “granule” includes granules, prills, pellets, small particles and grains, and has a mean particle size of at least 200, 300, 400, 500, 600, 700, 800, 900 or 1,000 μm.

The fertiliser composition of the present invention comprises granules, the granules comprising one or more plant hormones, such as gibberellic acid or a salt thereof, and optionally one or more carriers and/or one or more additional agents.

It should be appreciated that the granule can comprise the one or more plant hormones, such as gibberellic acid as
a coating of plant hormone about a granule,
a granule comprising a homogenous mix of one or more carriers and/or one or more additional agents and plant hormone, or
a granule comprising plant hormone in a carrier, encapsulated or coated by one or more carriers and/or one or more additional agents.

The granules of the present invention contain about 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3 mg of one or more plant hormones, such as gibberellic acid per gram of granule, and useful ranges may be selected between any of these values (for example, from about 0.01 to about 3, from about 0.01 to about 2.1, from about 0.01 to about 1.5, from about 0.01 to about 1.0, from about 0.01 to about 0.3, from about 0.05 to about 3, from about 0.05 to about 2.2, from about 0.05 to about 1.9, from about 0.05 to about 1.0, from about 0.05 to about 0.8, from about 0.05 to about 0.1, from about 0.2 to about 3, from about 0.2 to about 2.4, from about 0.2 to about 1.6, from about 0.2 to about 1.0, from about 0.2 to about 0.8, from about 0.75 to about 3, from about 0.75 to about 2.4, from about 0.75 to about 2, from about 0.75 to about 1.2, from about 1.1 to about 3, from about 1.1 to about 2.6, from about 1.1 to about 2.0, from about 1.1 to about 1.8, from about 1.1 to about 1.4, from about 1.7 to about 3, from about 1.7 to about 2.8, from about 1.7 to about 2.6, from about 1.7 to about 2.0, from about 2.0 to about 3.0, from about 2.0 to about 2.8 or from about 2.0 to about 2.2 mg of one or more plant hormones, such as gibberellic acid, per gram of granule).

In one embodiment, when applied as a coating the one or more plant hormones, such as gibberellic acid, partially coats the surface of the granule, or coats all of the granule, or any amount in between, for example a majority or substantially all of the granule.

The granules of the present invention a mean diameter of about 500, 600, 700, 800, 900, 1,000, 1,200, 1,400, 1,600, 1,800, 2,000, 2,200, 2,400, 2,600, 2,800, 3,000, 3,200, 3,400, 3,600, 3,800, 4,000, 4,200, 4,400, 4,600, 4,800 or 5,000 μm, and useful ranges may be selected between any of these values (for example, from about 500 to about 5,000, from about 500 to about 4,200, from about 500 to about 3,600, from about 500 to about 2,200, from about 500 to about 1,000, from about 700 to about 5,000, from about 700 to about 4400, from about 700 to about 3,800, from about 700 to about 1,600, from about 800 to about 5,000, from about 800 to about 4,800, from about 800 to about 3,400, from about 800 to about 3,000, from about 800 to about 1,200, from about 1,400 to about 5,000, from about 1,400 to about 4,400, from about 1,400 to about 3,000, from about 1,400 to about 2,600, from about 1,400 to about 2,000, from about 2,000 to about 5,000, from about 2,000 to about 4,800, from about 2,000 to about 4,200, from about 2,000 to about 3,800, from about 2,000 to about 3,400, from about 2,000 to about 3,200, from about 2,000 to about 3,000, from about 2,000 to about 2,800, from about 2,600 to about 5,000, from about 2,600 to about 3,400, from about 2,600 to about 3,000, from about 3,000 to about 5,000, from about 3,000 to about 4,400, from about 3,000 to about 4000, from about 3,600 to about 5,000, from about 3,600 to about 4,600, from about 3600 to about 4,000, from about 4,200 to about 5,000 or from about 4,200 to about 4,800 μm).

A specifically contemplated mean diameter range of the granules is about 2,000 to about 4,000 μm.

In various embodiments, the granules of the present invention have a particle size distribution whereby at least 90% of the granules have a diameter of from 1 mm to 5 mm. In one embodiment, the invention relates to a population of granules wherein at least 90% of the granules have a diameter within 1 mm of the mean diameter of the population.

In various embodiments the granules of the present invention have a bulk density of from about 0.5 g/cm³ to about 1.5 g/cm³. For example, the granules of the present invention have a bulk density of from about 0.6 g/cm³ to about 1.5 g/cm³, from about 0.7 g/cm³ to about 1.5 g/cm³, from about 0.8 g/cm³ to about 1.5 g/cm³, from about 0.9 g/cm³ to about 1.5 g/cm³, from about 1 g/cm³ to about 1.5 g/cm³, from about 1.1 g/cm³ to about 1.5 g/cm³, from about 1.2 g/cm³ to about 1.5 g/cm³, or from about 1.3 g/cm³ to about 1.5 g/cm³.

In another example, the granules of the present invention have a bulk density of from about 0.5 g/cm³ to about 1.4 g/cm³, from about 0.5 g/cm³ to about 1.3 g/cm³, from about 0.5 g/cm³ to about 1.2 g/cm³, from about 0.5 g/cm³ to about 1.1 g/cm³, from about 0.5 g/cm³ to about 1 g/cm³, from about 0.5 g/cm³ to about 0.9 g/cm³, or from about 0.5 g/cm³ to about 0.8 g/cm³.

In still another example, the granules of the present invention have a bulk density of from about 0.7 g/cm³ to about 1.4 g/cm³, from about 0.8 g/cm³ to about 1.3 g/cm³, from about 0.9 g/cm³ to about 1.2 g/cm³, from about 0.9 g/cm³ to about 1.1 g/cm³, or have a bulk density of about 1 g/cm³.

In one embodiment, the compositions of the invention comprise two or more populations of granules, wherein the two or more populations differ in one or more physical or compositional characteristic.

For example, in one embodiment, the composition of the invention comprises two or more populations of granules which differ in the plant hormone or mix of plant hormones, or in the one or more additional agents, present in each population of granules comprising the composition. In another embodiment, the composition of the invention comprises two or more populations of granules which differ in their mean diameter or bulk density, for example to allow different rates of uptake or release following distribution.

### Agricultural Carriers and Additional Agents

In various embodiments, the compositions or granules of the invention comprise one or more additional agents, such as one or more fertilizers, one or more trace elements, one or more nitrification inhibitors, one or more urease inhibitors, one or more growth stimulants, one or more microbes, or one or more other agriculturally acceptable agents.

Exemplary fertilizers include urea and other nitrogen-providing substances, super phosphates (whether single super phosphate) (“SSP”), double super phosphate (“DSP”) or triple super phosphate (“TSP”), or mixtures and derivatives thereof.

Nitrification inhibitors are substances that slow or stop the conversion of soil ammonium to nitrate. Exemplary nitrification inhibitors include N-2,5-dichlorophenyl succinamic acid, 2-chloro-6-trichloromethyl pyridine (“Nitrapyrin”), dicyandiamide (“DCD or “DCDIN”, which is HN=C(NH2)—NH—CN), zinc ethylene-bis-dithiocarbamate, 2,4,6-trichloroaniline, pentachlorophenol, thio-urea, ATS (ammonium thiosulphate), and pyrazole derivatives, such as DMPP (3,4 dimethylpyrazol phosphate), 3-MP (3-methylpyrazole) and/or DMP (3,4-dimethylpyrazole), including water soluble forms of pyrazole derivatives.

In various embodiments, the compositions or granules of the invention comprise from about 1% w/w to about 35% w/w one or more nitrification inhibitor.

Urease inhibitors, typically used to inhibit the activity of soil urease, can be classified according to their structure or function, and representative classes include sulphydryl reagents, hydroxamates, agricultural crop protection chemicals, and structural analogues of urea and related compounds, such as the organophosphorus inhibitors, particularly the phosphorodiamidates, the phosphorotriamides and the triophosphorotriamides.

Exemplary urease inhibitors suitable for use in the present invention include N-(n-butyl) thiophosphoric triamide (NBTPT or NBPT), cyclohexylphosphoric triamide (CHPT), cyclohexyl thiophosphoric triamide (CHTPT), cyclohexyl phosphric triamide (CNPT), phenyl phosphorodiamidate (PPDA), N-(n-butyl) phosphoric triamide (BNPO or NBPTO), thiophoshoryl triamide (TPT), phenyl phosphorodiamidate (PPD/PPDA), phosphoric triamide (PT), hydroquinone (HQ), P-benzoquinone, hexaamidocyclotriphosphazene (HACTP), thiophyridines, thiophyrimidines, thiophyridine-Noxides, NN-dihalo-2-imidazolidinone, and N-halo-2-oxazolidinone.

In various embodiments, the compositions or granules of the invention comprise at least one agriculturally acceptable carrier. Carriers useful herein include any substance typically used to formulate agricultural composition.

In one embodiment the agriculturally acceptable carrier is selected from the group comprising fillers, solvents, excipients, surfactants, suspending agents, speaders/stickers (adhesives), antifoaming agents, dispersants, wetting agents, drift reducing agents, auxiliaries, adjuvants or a mixture thereof.

For example, the at least one carrier is selected from the group consisting of a filler stimulant, an anti-caking agent, a wetting agent, an emulsifier, and an antioxidant, for example said composition comprises at least one of each of a filler stimulant, an anti-caking agent, a wetting agent, an emulsifier, and an antioxidant.

In one embodiment, said filler stimulant is a carbohydrate source, such as a disaccharide including, for example, sucrose, an oligosaccharide including for example starch, fructose, glucose, mannitol or dextrose, said anti-caking agent is selected from talc, silicon dioxide, calcium silicate, or kaolin clay, said wetting agent is skimmed milk powder, or any commercially available product such as Duwett™, Latron™, said emulsifier is a soy-based emulsifier such as lecithin or a vegetable-based emulsifier such as monodiglyceride, and said antioxidant is sodium glutamate or citric acid or potassium sorbate or an alcohol.

In one embodiment solid carriers include but are not limited to mineral earths such as silicic acids, silica gels, silicates, talc, kaolin, attapulgus clay, limestone, lime, chalk, bole, loess, clay, bentonite, dolomite, diatomaceous earth, aluminas calcium sulfate, magnesium sulfate, magnesium oxide, peat, humates, ground plastics, fertilizers such as ammonium sulfate, ammonium phosphate, ammonium nitrate, and ureas, and vegetable products such as grain meals, bark meal, wood meal, and nutshell meal, cellulosic powders, seaweed powders, peat, talc, carbohydrates such as mono-saccharides and di-saccharides, starch extracted from corn or potato or tapioca, chemically or physically altered corn starch and the like. As solid carriers for granules the following are suitable: crushed or fractionated natural rocks such as calcite, marble, pumice, sepiolite and dolomite; synthetic granules of inorganic or organic meals; granules of organic material such as sawdust, coconut shells, corn cobs, corn husks or tobacco stalks; kieselguhr, tricalcium phosphate, powdered cork, or absorbent carbon black; water soluble polymers, resins, waxes; or solid fertilizers. Such solid compositions may, if desired, contain one or more compatible wetting, dispersing, emulsifying or colouring agents which, when solid, may also serve as a diluent.

In various embodiments, the carrier used during preparation of the granules or compositions of the invention is a liquid, for example, water; alcohols, particularly butanol or glycol, as well as their ethers or esters, particularly methylglycol acetate; ketones, particularly acetone, cyclohexanone, methylethyl ketone, methylisobutylketone, or isophorone; petroleum fractions such as paraffinic or aromatic hydrocarbons, particularly xylenes or alkyl naphthalenes; mineral or vegetable oils; aliphatic chlorinated hydrocarbons, particularly trichloroethane or methylene chloride; aromatic chlorinated hydrocarbons, particularly chlorobenzenes; water-soluble or strongly polar solvents such as dimethylformamide, dimethyl sulfoxide, or N-methylpyrrolidone; liquefied gases; or the like or a mixture thereof.

In one embodiment surfactants include nonionic surfactants, anionic surfactants, cationic surfactants and/or amphoteric surfactants. Said surfactants are typically used during preparation of the granules and compositions of the invention.

Spreaders/stickers promote the ability of the compositions of the invention to adhere to surfaces, and/or the ability of the components of the granules of the invention to adhere to one another during preparation. Examples of surfactants, spreaders/stickers include but are not limited to Tween and Triton (Rhom and Hass Company), Fortune®, Pulse, C. Daxoil®, Codacide oil®, D-C. Tate®, Supamet Oil, Bond®, Penetrant, Glowelt®, and Freeway, Citowett®, Fortune Plus™, Fortune Plus Lite, Fruimec, Fruimec lite, alkali metal, alkaline earth metal and ammonium salts of aromatic sulfonic acids, e.g., ligninsulfonic acid, phenolsulfonic acid, naphthalenesulfonic acid and dibutylnaphthalenesulfonic acid, and of fatty acids, alkyl and alkylaryl sulfonates, and alkyl, lauryl ether and fatty alcohol sulfates, and salts of sulfated hexadecanols, heptadecanols, and octadecanols, salts of fatty alcohol glycol ethers, condensation products of sulfonated naphthalene and naphthalene derivatives with formaldehyde, condensation products of naphthalene or naphthalenesulfonic acids with phenol and formaldehyde, polyoxyethylene octylphenol ethers, ethoxylated isooctylphenol, ethoxylated octylphenol and ethoxylated nonylphenol, alkylphenol polyglycol ethers, tributylphenyl polyglycol ethers, alkylaryl polyether alcohols, isotridecyl alcohol, fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methyl cellulose. Where selected for inclusion, one or more agricultural surfactants, such as Tween are desirably included in the composition according to known protocols.

In various embodiments wetting agents are used in the methods of preparation of the granules and compositions of the invention. Examples of wetting agents include but are not limited to salts of polyacrylic acids, salts of lignosulfonic acids, salts of phenolsulfonic or naphthalenesulfonic acids, polycondensates of ethylene oxide with fatty alcohols or fatty acids or fatty esters or fatty amines, substituted phenols (particularly alkylphenols or arylphenols), salts of sulfosuccinic acid esters, taurine derivatives (particularly alkyltaurates), phosphoric esters of alcohols or of polycondensates of ethylene oxide with phenols, esters of fatty acids with polyols, or sulfate, sulfonate or phosphate functional derivatives of the above compounds.

As described herein, the compositions or granules of the present invention are in various embodiments formulated with, and in other embodiments used in combination with one or more other agricultural agents, including pesticides, insecticides, acaracides, additional fungicides, bactericides, herbicides, antibiotics, antiphytopathogenic microbials, nematicides, rodenticides, entomopathogens, pheromones, attractants, plant growth regulators, plant hormones, insect growth regulators, chemosterilants, phytopathogenic microbial pest control agents, repellents, viruses, phagostimulents, plant nutrients, plant fertilisers and biological controls.

When used in combination with other agricultural agents the administration of the two agents may be separate, simultaneous or sequential. Specific examples of these agricultural agents are known to those skilled in the art, and many are readily commercially available.

Examples of plant nutrients include but are not limited to nitrogen, magnesium, calcium, boron, potassium, copper, iron, phosphorus, sulphate, manganese, molybdenum, cobalt, boron, copper, silicon, selenium, nickel, aluminium, chromium and zinc.

Examples of antibiotics include but are not limited to oxytetracyline and streptomycin.

Examples of fungicides include but are not limited to the following classes of fungicides: carboxamides, benzimidazoles, triazoles, hydroxypyridines, dicarboxamides, phenylamides, thiadiazoles, carbamates, cyano-oximes, cinnamic acid derivatives, morpholines, imidazoles, beta-methoxy acrylates and pyridines/pyrimidines.

Further examples of fungicides include but are not limited to natural fungicides, organic fungicides, sulphur-based fungicides, copper/calcium fungicides and elicitors of plant host defences.

Examples of natural fungicides include but are not limited to whole milk, whey, fatty acids or esterified fatty acids.

Examples of organic fungicides include but are not limited to any fungicide which passes an organic certification standard such as biocontrol agents, natural products, elicitors (some of may also be classed as natural products), and sulphur and copper fungicides (limited to restricted use).

An example of a sulphur-based fungicide is Kumulus™ DF (BASF, Germany). An example of a copper fungicide is Kocide® 2000 DF (Griffin Corporation, USA).

Examples of elicitors include but are not limited to chitosan, Bion™, BABA (DL-3-amino-n-butanoic acid, (3-aminobutyric acid), salicylic acid or its derivatives (e.g. Actigard, Syngenta) and Milsana™ (Western Farm Service, Inc., USA).

In some embodiments non-organic fungicides may be employed. Examples of non-organic fungicides include but are not limited to Bravo™ (for control of powdery mildew on cucurbits); Supershield™ (Yates, NZ) (for control of Botrytis and powdery mildew on roses); Topas® 200EW (for control of PM on grapes and cucurbits); Flint™ (for control of powdery mildew on apples and cucurbits); Amistar® WG (for control of rust and powdery mildew on cereals); and Captan™, Dithane™, Euparen™, Rovral™, Scala™, Shirlan™, Switch™ and TeldorTM (for control of Botrytis on grapes).

Examples of pesticides include but are not limited to azoxystrobin, bitertanol, carboxin, Cu₂O, copper hydroxide, copper sulphate, cymoxanil, cyproconazole, cyprodinil, dichlofluamid, difenoconazole, diniconazole, epoxiconazole, fenpiclonil, fludioxonil, fluquiconazole, flusilazole, flutriafol, furalaxyl, guazatin, hexaconazole, hymexazol, imazalil, imibenconazole, ipconazole, kresoxim-methyl, lime sulphur, mancozeb, metalaxyl, R-metalaxyl, metconazole, oxadixyl, pefurazoate, penconazole, pencycuron, prochloraz, propiconazole, pyroquilone, SSF-109, spiroxamin, tebuconazole, thiabendazole, tolifluamid, triazoxide, triadimefon, triadimenol, triflumizole, triticonazole and uniconazole.

An example of a biological control agent other than a bacterial strain of the present invention is the BotryZen™ biological control agent comprising Ulocladium oudemansii.

Specifically contemplated embodiments of compositions and granules of the invention comprise trace elements, such as but not limited to manganese, magnesium, zinc, potassium, sodium, cobalt, sulphur (which may conveniently be provided as a sulphate), molybdate, copper, and iron (which may conveniently be provided as a chelate); carbohydrates, such as but not limited to molasses; one or more gums, such as but not limited to guar gum, xanthan gum, locust bean gum, cassia gum, konjac flour, beta-glucan, tara gum, gum arabic, gellan gum, carboxymethylcellulose, methylcellulose, hydroxypropyl methylcellulose, tragacanth gum, karaya gum, gum acacia, chitosan, arabinoglactins, alginate, pectin, carrageenan, or psyllium; acids, particularly weak acids such as citric acid, sorbic acid, sorbate and other ingredients, such as one or more algae, seaweed, or extracts thereof.

An exemplary granule of the invention comprises a carrier core coated in a sticking agent, such as a polyvinyl acetate or gum, to which is applied plant hormone, such as gibberrellic acid.

### Manufacturing Method

Processes for the preparation of granules for use in agricultural applications are known, and will be apparent to a person skilled in the art on reading the present specification. In some embodiments the one or more plant hormones, such as gibberellic acid, is coated onto the granule. It should be appreciated that the coating could be in a wet or dry form. For example, if applied in wet form the one or more plant hormones, such as gibberellic acid, in one embodiment consists as a mixture of one or more plant hormones in a carrier. The carrier is, for example, water, an alcohol, or an organic solvent. Examples of possible organic solvents include primary, secondary and tertiary alcohols from C₁ to C₁₀, such as propanol and iso-propanol. The mixture of gibberellic acid in the carrier may be present as a solution or slurry. In one embodiment the gibberellic acid is dissolved in the carrier. The gibberellic acid is then sprayed onto, incorporated into or impregnated onto the granule or granules.

With wet granulation, granules are formed by addition of a granulation liquid, such as water, ethanol and isopropanol or any volatile solvent that is readily removed by drying, onto a bed of powdered carrier. The powdered bed is agitated by an impeller, screws or air stream. The agitation imparted by the impeller, screws or air stream combined with wetting of the components by the granulation liquid results in aggregation of the powder particles of carrier to produce wet granules that are then dried.

Dry granulation is used to form granules without using a liquid solution, by compacting and densifying the powders. Powder particles are aggregated under high pressure using, for example, a tableting machine for batch production or a roller compactor for continuous production.

When applied in a dry form the one or more plant hormones, such as gibberellic acid, may be in the form of a dry powder. The one or more plant hormones, such as gibberellic acid, when applied to the granule, will form a particulate coating about the granule.

In another embodiment one or more carriers and/or one or more additional agents and one or more plant hormones, such as gibberellic acid, are mixed together as a slurry or dry powder. For example, the one or more carriers and/or one or more additional agents is prepared as a slurry into which the one or more plant hormones, such as gibberellic acid, is mixed, or the one or more plant hormones is prepared as a slurry into which the one or more carriers and/or one or more additional agents is mixed. Alternately, dry forms of the one or more plant hormones and one or more carriers and/or one or more additional agents are mixed together.

When mixed in a slurry or dry form the one or more carriers and/or one or more additional agents and one or more plant hormones, such as gibberellic acid, may be pressed formed into a granule, for example as a pressed pellet. Exemplary pressing conditions for pellet production are 5 tonne on 1 cm² for 30 sec, although those skilled in the art would appreciate that other pelleting conditions can be utilised.

As described above, the one or more plant hormones, such as gibberellic acid, may be present with the one or more carriers and/or one or more additional agents when granulation occurs. This method for forming the granule can include the preparation of molten carriers and/or additional agents to which one or more plant hormones is added prior to the mixture being sprayed into a granulator. Exemplary carrier/additional agent compositions comprising urea have to be heated to above the melting point of urea, meaning heating to above about 130° C.

An alternate method is the production in prilled form of one or more carriers and/or one or more additional agents that is subsequently coated in one or more plant hormones, or of a mixture of one or more carriers and/or one or more additional agents and one or more plant hormones, optionally together with one or more additional agents, carriers or the like.

When supplied as a surface preparation after production of the granule or prill, the one or more plant hormones, such as gibberellic acid, may be sprayed as a salt, for example a gibberellic acid salt (e.g. ammonium or potassium salt). Typically the composition to be sprayed will also include a carrier such as monopropylene glycol (MPG) which aids the even coating of the plant hormone on the surface of the granule or the prill. The carrier may be, for example, water, an alcohol, or an organic solvent. Examples of possible organic solvents include primary, secondary and tertiary alcohols from C₁ to C₁₀, such as propanol and iso-propanol.

As mentioned above, the granule can comprise one or more plant hormones, such as gibberellic acid, and one or more carriers and/or one or more additional agents as a granule comprising plant hormone in a carrier, encapsulated or coated by the one or more carriers and/or one or more additional agents. In this embodiment it is necessary to create a solid particle with mass that can be coated or encapsulated by the carrier or additional agent. For example, the plant hormone can first be formed into a granule with a carrier. In specifically contemplated embodiments, the carrier for the plant hormone is a bentonite such as potassium, sodium, calcium, or aluminium bentonite, and the carrier is a zeolite (e.g. mordenite) or perlite. Once formed, the one or more carriers and/or one or more additional agents is then applied to the plant hormone granule, for example by spraying or granulation.

When urea is included, the urea incorporated into the granule is selected from any source of urea. For example, urea phosphate, urea sulphur or urea potash.

### Application to Soil

In accordance with the invention, the granules are spread onto a plant or a locus in which a plant is or is to be planted, such as, for example, a pasture. The granules may be spread by spraying, blowing, spinning or pneumatic application the granules such that the granules cover 5, 10, 15, 20, 25, 30, 35, 40, 45, 50, 55, 60, 65, 70, 75, 80, 85, 90, 95 or 100% of the plants or locus, such as the pasture.

In one embodiment the granules are applied, for example to pasture, to provide about 5, 10, 15, 20, 25, 30, 35, 40, 45, 50, 55, 60, 65, 70, 75, 80, 85, 90, 95 or 100 g/Ha of one or more plant hormones, such as gibberellic acid or a salt thereof, and useful ranges may be selected between any of these values (for example, about 5 to about 100, about 5 to about 90, about 5 to about 75, about 5 to about 60, about 5 to about 55, about 5 to about 40, about 5 to about 30, about 5 to about 20, about 10 to about 95, about 10 to about 90, about 10 to about 80, about 10 to about 70, about 10 to about 60, about 10 to about 55, about 10 to about 40, about 10 to about 30, about 10 to about 20, about 15 to about 90, about 15 to about 80, about 15 to about 60, about 15 to about 50, about 20 to about 100, about 20 to about 90, about 20 to about 85, about 20 to about 80, about 20 to about 75, about 20 to about 60, about 20 to about 55, about 20 to about 40, about 25 to about 100, about 25 to about 80, about 25 to about 75, about 25 to about 60, about 25 to about 55, about 25 to about 40, about 30 to about 100, about 30 to about 90, about 30 to about 80, about 30 to about 70, about 30 to about 60, about 30 to about 50, about 40 to about 100, about 40 to about 95, about 40 to about 85, about 40 to about 65, about 40 to about 60, about 40 to about 55, about 50 to about 100, about 50 to about 80, about 50 to about 70, about 50 to about 60, about 60 to about 100, about 60 to about 85, about 60 to about 75, about 75 to about 100, about 75 to about 80, about 85 to about 100, about 85 to about 90 or about 90 to about 100 g/Ha).

In one embodiment, the granules increase pasture dry matter production by at least about 10, 15, 20, 25, 30, 35, 40, 45, 50, 55, 60, 65, 70, 75, 80, 85, 90, 95 or 100%, and useful ranges may be selected between any of these values (for example, about 10 to about 95, about 10 to about 90, about 10 to about 80, about 10 to about 70, about 10 to about 60, about 10 to about 55, about 10 to about 40, about 10 to about 30, about 10 to about 20, about 15 to about 90, about 15 to about 80, about 15 to about 60, about 15 to about 50, about 20 to about 100, about 20 to about 90, about 20 to about 85, about 20 to about 80, about 20 to about 75, about 20 to about 60, about 20 to about 55, about 20 to about 40, about 25 to about 100, about 25 to about 80, about 25 to about 75, about 25 to about 60, about 25 to about 55, about 25 to about 40, about 30 to about 100, about 30 to about 90, about 30 to about 80, about 30 to about 70, about 30 to about 60, about 30 to about 50, about 40 to about 100, about 40 to about 95, about 40 to about 85, about 40 to about 65, about 40 to about 60, about 40 to about 55, about 50 to about 100, about 50 to about 80, about 50 to about 70, about 50 to about 60, about 60 to about 100, about 60 to about 85, about 60 to about 75, about 75 to about 100, about 75 to about 80, about 85 to about 100, about 85 to about 90 or about 90 to about 100%).

The granular fertiliser can be spread onto soil, pasture, crops, arable land in accordance with known application methods. For example, the granular fertiliser can be loaded into a vehicle mounted hopper and distributed onto the soil. Spraying, blowing and spinning are commonly used methods of distributing granular compositions, and spinner trucks and blower trucks, as are commonly used in the art, are convenient vehicles to distribute the compositions and granules of the invention. Application by side dressing could also be carried out. It should be appreciated that aerial spraying could also be used. In one embodiment the exemplary method of applying the granules or compositions of the invention is to spray or distribute the granules by handgun or commercial airblast, for example using air-drilling or other pneumatic techniques.

The granules could also be applied to the soil by subsurface application. Standard processes could be used as known in the art, such as drilling and air-drilling.

In one embodiment application of irrigation water follows application of the plant hormone-coated granule to the soil. It should be appreciated that rain subsequent to the granular fertiliser soil application may also be sufficient to disperse the granular fertiliser into the soil.

### Use of the Fertiliser Granule

The granules of the present invention are suitable for providing fertilizer to any plants, or to any locus in which a plant is or is to be grown. Application to agriculturally important plants, such as pasture, horticultural plants, flowers, cropping plants, such as vegetables including brassicas, cucubits, and legumes,cereals, fruits, etc, are particularly contemplated.

Advantages of the fertiliser granule of the present invention include
ease of manufacture
ease of handling, and
ease of application.

In relation to the ease of manufacture, the manufacture of granules produces less dust compared to the manufacture of a powder.

The applicants believe, without wishing to be bound by any theory, that in comparison to a liquid formulation, the shelf life of a granule is improved, potentially around twice as long compared to a liquid formulation. Additionally, in terms of application, there is an advantage of granule application over liquid, at least in part because there is no need to transport water or large volumes of liquid.

The invention has particular application to plants and plant products, either pre- or post-harvest. For example, the composition of the invention may be applied to stored products of the type listed above including fruits, vegetables, cut flowers and seeds. Suitable application techniques encompass those identified above, particularly spraying, blowing, spinning or pneumatic application.

The compositions and granules of the invention can be used to treat or pretreat soils or seeds. The compositions and granules of the invention also find use in plant processing materials such as protective coatings, boxes and wrappers.

The invention consists in the foregoing and also envisages constructions of which the following gives examples only and in no way limit the scope thereof.

### Example

This example describes the preparation of auxin-coated granules and their application to soil.

### Trial Design

### Treatment Groups

The trial is carried out with a total of eight treatments. The eight treatment groups are
1. Control—negative control (no nitrogen or auxin),
2. AU-20—auxin (IAA) positive control (auxin applied at 20 g/ha),
3. UG-20—granular urea positive control (granular urea applied at a rate of 20 kg N/ha,
4. UG-20+AU-10—10 g/ha auxin-coated urea granules (granular urea-20 coated with auxin to apply auxin at a rate of 10 g/ha),
5. UG-20+AU-30—30 g/ha auxin-coated urea granules (granular urea-20 coated with auxin to apply auxin at a rate of 30 g/ha), and
6. UG-20+AU-60—60 g/ha auxin-coated urea granules (granular urea-20 coated with auxin to apply auxin at a rate of 60 g/ha).
7. UL-20—liquid urea positive control (liquid urea applied at a rate of 20 kg N/ha [with total liquid volume of 200 L/ha]), and
8. UL-20+AU-20—liquid urea and auxin positive control (liquid urea applied at a rate of 20 kg N/ha with auxin applied at a rate of 20 g/ha).

### Trial Methodology

The trial is performed with four repetitions per treatment group on a plot with an area of 2 m²×2 m² at various locations.

The treatments are applied on grazed pasture. All experimental sites are fenced off four months prior to treatment application to avoid nitrogen inputs from grazing animals and fertiliser application. At each site, four blocks separated by a 1 m buffer are established. Each block contains eight small plots (each plot of 2 m²×2 m²) separated by a 1 m buffer zone to give a total of 32 plots.

The above eight treatments are applied in mid August. Before treatments application, four composite soil samples (0-10 cm soil depth), are collected for key soil properties (i.e. soil pH, organic C &N, Olsen P, K, Ca, Mg, CEC, base saturation and MAF quick test). Each composite soil sample comprises 10 randomly collected soil samples from each block. Pastures from each plot are cut at 4 to 5 cm height using a lawn mower at appropriate times (preferably after every 21 days) to simulate rotational grazing practices. Bulk fresh pasture weight for each plot is recorded. Before mowing pastures from each plot, four small randomly picked pasture samples from each plot are cut using a pair of scissors. Fresh pastures are transferred to sealable plastic bags and are kept in a chilly bin. Fresh pastures from each plastic bag are then transferred to a pre-weighed paper bag, weighed (at least 2 decimal balance), and dried at 60 to 70° C. for one week. After one week of drying, dry pasture weight is recorded to determine pasture moisture content.

In the case of liquid treatments, these are all applied at a rate of 200 L/ha.

The effectiveness of the treatments is measured by comparing the pasture shoot dry matter from two cuts after treatment application. The first cut is made in mid-late September and the second cut is made in mid-October.

Results

Cumulative results for each of the five treatment areas are recorded.

Pairwise comparison for the results are prepared, calculated using Fisher's least significant difference (LSD) with P=0.05.

Results demonstrating that the fertiliser granules containing urea and auxin are more effective or equally as effective as those agents applied in liquid form support the efficacy of granules of the present invention.

### Example 2

This example describes the preparation of granules comprising the auxin indole-3-butyric acid (IBA), granules comprising abscisic acid (ABA), and granules comprising the cytokinin zeatin, and their application to soil.

### Trial Design

### Treatment Groups

The trial is carried out with a total of eight treatments for each hormone. The eight treatment groups as described in Example 1 above, where the auxin is substituted IBA, ABA, and zeatin, respectively.

### Trial Methodology

The trial is performed as described in Example 2 above.

The effectiveness of the treatments is measured by comparing the pasture shoot dry matter from two cuts after treatment application. The first cut is made in mid-late September and the second cut is made in mid-October.

### Results

Cumulative results for each of the treatment areas are recorded.

Pairwise comparison for each hormone treatment group of the results are prepared, calculated using Fisher's least significant difference (LSD) with P=0.05.

Results demonstrating that the fertiliser granules containing urea and each respective plant hormone are more effective or equally as effective as those hormones applied in liquid form support the efficacy of granules of the present invention.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A fertiliser composition comprising granules, the granules comprising one or more plant hormones, wherein the granules
a) have a bulk density of from about 0.5 g/cm³ to about 1.5 g/cm³, or
b) have a mean diameter (weight-based) of from about 1 mm to 5 mm, or
c) have a particle size distribution whereby at least 90% of the granules have a diameter of from 1 mm to 5 mm, or
d) have, a particle size distribution whereby at least 90% of the granules have a. diameter within 1 mm of the mean diameter, or
e) have a hardness of from about 10 N to about 70 N, or
f) comprise less than about 0.5% w/w plant hormone, or
g) any combination of two or more of to (r) above,

2. The fertiliser composition of claim 1 wherein the granules have a mean diameter of about 500 μm, 600, 700, 800, 900, 1000, 1200, 1400, 1600, 1800, 2000, 2200, 2400, 2600, 2800, 3000, 3200, 3400, 3600, 3800, 4000, 4200, 4400, 4600, 4800 or 5000 μm.

3. The fertiliser composition of claim 2 wherein. the granules have a mean diameter of from about 2000 μm to about 4000 μm.

4. The fertiliser composition of claim 1 wherein the granules have a bulk density of from about 0.5 g/cm³ to about 1.5 g/cm³ and a particle size distribution whereby at least 90% of the granules have a diameter within 1 mm of the mean diameter of the granules.

5. The fertiliser composition of claim 1 wherein the granules comprise about 0,01, 0.05, 0.1, 0.15, 0.2, 0.25, 0.3, 0,35, 0.4, 0.45, 0.5, 0.55, 0.6, 0.65, 0.7, 0.75, 0.8, 0.85, 0.9, 0.95, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3 mg plant hormone per gram of granule.

6. The fertiliser composition of claim 1 wherein the plant hormone coats at least 25% of the granule surface.

7. The fertiliser composition of claim 1 wherein the granules comprise one or more carriers and/or one or more additional agents coated with one or more plant hormones.

8. The fertiliser composition of claim 1. wherein the granules consist of a granule at least partially dry coated with one or more plant hormones, such as gibberellic acid or a salt thereof.

9. The fertiliser composition of claim 1 wherein the granules consist of a granule at least partially wet coated with one or more plant hormones, such as gibberellic acid or a salt thereof.

10. The fertiliser composition of claim 1 wherein the granules comprise not more than about 3 mg of one or more plant hormones, such as gibberellic acid or salt, thereof per gram of granule.

11. The fertiliser composition of claim 1 wherein the one or more plant hormones, such as qibberellic acid or a salt thereof at least partially coats the granule surface.

12. The fertiliser composition of claim 1 wherein the one or more plant hormones, such as gibberellic acid or a salt thereof coats at least 10, 15, 20, 25, 30, 35, 40, 45, 50, 55, 60, 65, 70, 75, 80, 85, 90 or 95% of the granule surface.

13. The fertiliser composition of claim 12 wherein. the one or more plant hormones, such as gibberellic acid or a salt thereof coats at least 75% of the granule surface.

14. The fertiliser composition of claim 1 wherein the one or more plant hormones, such as gibberellic acid or a salt thereof is sprayed onto the granules,

15. The fertiliser composition of claim 1 wherein one or more granules comprise urea.

16. A method of producing granules comprising urea and one or more plant hormones, the method comprising
(A) providing one or more ulant hormones,
(B) forming granules comprising the one or more plant hormones by
i) wet or dry mixing the one or more plant hormones and optionally one or more carriers and/or one or more additional agents and granulating the mixture, or
ii) granulating one or more carriers and/or one or more additional agents and at least partially coating the granule with the one or more plant hormones, or
iii) granulating a composition of the one or more plant hormones and an agriculturally acceptable carrier and at least partially coating the granule with one or more carriers and/or one or more additional agents, or
iv) any combination of (i) to (iii) above, and
(C) recovering the granules.

17. The method of claim 16 wherein the plant hormone is gibberellic acid or a salt thereof.

18. The method of claim 17 wherein the gibberellic acid is carried by an application carrier before being coated onto the granule.

19. The method of claim 18 wherein the application carrier is selected from water, an alcohol, or an organic solvent or a mixture thereof.

20. The method of claim 19 wherein the application carrier is a primary, secondary and tertiary alcohols with C1 to C10.

21. The method of claim 16 wherein granules comprise a substantially homogeneous mixture of one or more carriers and/or one or more additional agents and gibberellic acid or a salt thereof.

22. The method of claim 16 wherein the granules comprise a granulation carrier in combination with the one or more plant hormones that is subsequently at least partially coated by one or more carriers and/or one or more additional agents.

23. The method of claim 22 wherein the granulation carrier is selected from potassium, sodium, calcium, or aluminium bentonite, a zeolite, mordenite or perlite,

24. A method of providing fertilizer to a plant or a locus at which a plant is or is to be planted, the method comprising applying granules comprising one or more plant hormones or a composition comprising said granules to the plant or the locus, wherein the granules
a) have a bulk density of from about 0.5 g/cm³ to about g/cm, or
b) have a mean diameter (weight-based) of from about 1 mm to 5 mm, or
c) have a particle size distribution whereby at least 90% of the granules have a diameter of from 1 mm to 5 mm, or
d) have a particle size distribution whereby at least 90% of the granules have a diameter within 1 mm of the mean diameter, or
e) have a hardness of from about 10 N to about 70 N, or
f) comprise less than about 0.5% w/w plant hormone, or
g) any combination of two or more of (a) to (f) above.

25. A method of improving plant health, production, or nutritional, economic or environmental value, or of improving the health-promoting or productive capacity or the nutritional, economic or environmental value of a locus where a plant is or is to be planted, the method comprising applying granules comprising one or more plant hormones or a composition comprising said granules to the plant or the locus, wherein the granules
have a bulk density of from about 0.5 g/cm³ to about 1.5 g/cm³, or
have a mean diameter (weight-based) of from about 1 mm
have a particle size distribution whereby at least 90% of the granules have a diameter of from 1 mm to 5 mm, or
have a particle size distribution whereby at least 90% of the granules have a diameter within 1 mm of the mean diameter, or
have a hardness of from about 10 N to about 70 N, or
comprise less than about 0.5% w/w plant hormone, or
any combination of two or more of (a) to (f) above,

26. The method of claim 25 wherein the improvement is an improvement in plant yield.

27. The method of claim 25 wherein the improvement is a reduction in plant nitrogen concentration.

28. The method of claim 25 wherein the improvement is a reduction in nitrate levels and/or nitrate poisoning or risk of nitrate poisoning.

29. The method of claim 25 wherein the application is to pasture and the improvement is
a) a reduction in cadmium intake by one or more animals grazing on said pasture, or
b) a reduction in cadmium concentration in plants on said pasture, or
c) a reduction in the urea or nitrogen intake by or concentration of forage or pasture, arazed by in one or more animals grazing on said pasture, or
d) a reduction in the urea or nitrogen concentration in a product of one or more animals grazing on said pasture, or
e) a reduction in urea or nitrogen output of an animal grazing on said pasture, or
f) a reduction in cation leaching, or
g) a reduction in nitrous oxide production, or
h) a reduction in nitrogen leaching, or
i) any combination of two or more of (a) to (h) above.

30. The method of claim 29 wherein the one or more animals grazing on said pasture are bovine and the improvement is a reduction in the urea concentration of milk from said bovine.

31. The method or claim 24 wherein the granules are applied by spraying, blowing, spinning or pneumatic application.

32. The method of claim 24 wherein the granules are applied. to provide about 5, 10, 15, 20, 25, 30, 35, 40, 45, 50, 55, 60, 65, 70, 75, 80, 85, 90, 95 or 100 a of plant hormone per hectare.

33. The method of claim 24 wherein the granules are applied to pasture to provide about 10 to about 30 g of plant hormone per hectare.

34. The method of claim 32 wherein the plant hormone is gibberellic acid or a salt thereof.

35. The method of treating the soil of pastoral land to increase pasture production, the method comprising applying granules as claimedd, in claim 1 to the soil of pastoral land to increase pasture production.

36. The method of claim 35 wherein the granules increase pasture growth.

37. The method of claim 35 wherein the granules increase pasture dry matter production by at least about 10, 15, 20, 25, 30, 35, 40, 45, 50, 55, 60, 65, 70, 75, 80, 85, 90, 99 or 100%.

38. The method of claim 35 wherein the granules increase pasture dry matter production by at least about 15 to about 50%.

39. The method of claim 35 wherein the granules are applied before application of irrigation water or before a period of forecast rainfall.

40. The method of claim 35 wherein the granules are applied to substantially cover a pasture.
